(19) United States
(12) Patent Application Publication
(10) Pub. No.: US 2020/0063718 A1
(43) Pub. Date: Feb. 27, 2020

(54) LEADING EDGE PROTECTION OF A WIND TURBINE BLADE

(71) Applicant: MHI Vestas Offshore Wind A/S, Aarhus N (DK)

(72) Inventors: Wout Ruijter, Silkeborg (DK); Christian Meldgaard, Rønde (DK); Brian Bækdahl Damgaard, Hørning (DK)

(21) Appl. No.: 16/484,859

(22) PCT Filed: Feb. 16, 2018
(86) PCT No.: PCT/EP2018/053893

§ 371 Date: Aug. 9, 2019

(30) Foreign Application Priority Data
Feb. 17, 2017 (DK) PA 2017 70106

(51) Int. Cl. F03D 80/50; F03D 1/06

(52) U.S. Cl. CPC F03D 80/50; F03D 1/0683; F05B 2280/60; F05B 2240/30; F05B 2230/31

(57) ABSTRACT

The invention relates to a leading edge protection cover for a wind turbine blade. The protection cover comprises first and second longitudinally extending edges, and outer and inner arcuate surfaces extending there between. The inner arcuate surface is shaped to be attached to an outer surface portion of the wind turbine blade such as to cover at least a part of the leading edge of the blade, and with the first longitudinally extending edge being attached to a suction side of the wind turbine blade. The protection cover further comprises a number of vortex generating members positioned on the outer arcuate surface of the protection cover along at least a part of the first longitudinally extending edge. The proposed protection cover results in an increased protection of the wind turbine blade against impacting particles and improved fluid properties over the surface of the wind turbine blade. The invention further relates to a method of preparing a wind turbine blade with a leading edge protection cover, comprising the steps of moulding a leading edge protection cover comprising a number of vortex generating members and attaching the leading edge protection cover to an outer surface portion of the wind turbine blade.

### FIELD OF THE INVENTION

The present invention relates to a leading edge protection cover for a wind turbine blade. The invention furthermore relates to a method of manufacturing such leading edge protection cover.

### BACKGROUND OF THE INVENTION

Modern wind turbines continue to grow in size and be equipped with increasingly long wind turbine blades in order to increase the power production. As the blades get longer, the velocities of the particles impacting on the blade surface are correspondingly increased. Rain, hail, salt spray and other debris particles impact the blade surface at up to 400 km/h or even more potentially causing significant erosion damage. Especially the leading edge of the wind turbine and in particular the outermost part of the wind turbine blade closest to the tip is exposed to erosion. If the wind turbine blades are not sufficiently protected or if the protection is worn away, the blades are over time seen to suffer pitting, gouging and delamination, which may affect the aerodynamic efficiency and structural integrity. Poor blade performance may reduce annual energy production, and repair downtime is costly.

Leading edge protection can be obtained by the application of coatings or tapes to the leading edge area for increased erosion protection. Such coatings or tapes are however difficult to apply on site for increased protection or repair of a wind turbine blade when mounted and can only be applied under favourable weather conditions. Further, erosion tapes have been seen to rupture with partly loose tape portions left to flutter freely in the wind. This decreases the aerodynamic performance of the blade and may form a significant source of noise.

It is also known to mount a pre-manufactured protection cover or shield on the outer surface of the finished wind turbine as described in e.g. WO 16075619. However, a pre-manufactured cover can be difficult to manufacture such as to closely fit the 3-dimensional blade geometry along a length of the leading edge which is necessary to obtain a strong bond to the blade. Further, a smooth transition from the cover to the blade shell is difficult to obtain and often involves time consuming fitting and use of a liquid filler product, and which can only be carried out under adequate weather conditions. A non-smooth transition with a small step from the cover to the blade shell may on the other hand potentially cause early stall of the blade with related increased drag and loss of lift and thereby energy production.

### OBJECT OF THE INVENTION

It is an object of embodiments of the present invention to overcome or at least reduce some or all of the above described disadvantages by providing a leading edge protection cover for a wind turbine blade with improved aerodynamic properties and especially improved lift.

It is an object of embodiments of the invention to provide a leading edge protection cover well suited for being attached to a wind turbine blade both during the manufacturing process of the wind turbine blade as well as during repair or maintenance and in particular for on-site operations.

A further object of embodiments of the invention is to provide a leading edge protection cover which is robust yet can be manufactured and attached to a wind turbine blade in a simple way.

So, in a first aspect the present invention relates to a leading edge protection cover for a wind turbine blade, the wind turbine blade extending longitudinally between a root end and a tip end of the blade, and extending transversely between a trailing edge and a leading edge. The protection cover comprises first and second longitudinally extending edges, and outer and inner arcuate surfaces extending there between, and the inner arcuate surface is shaped to be attached to an outer surface portion of the wind turbine blade comprising at least a part of the leading edge and with the first longitudinally extending edge being attached to a suction side of the wind turbine blade. The protection cover is configured to be statically fixed to the wind turbine blade. The protection cover further comprises a number of vortex generating members positioned on the outer arcuate surface of the protection cover along at least a part of the first longitudinally extending edge and the vortex generating members are formed integrally with the protection cover.

Hereby is obtained a protection cover providing an improved protection against erosion and wear of the leading edge of the wind turbine blade which is generally the part of the blade exposed to the highest loading by impacting particles or projectiles such as rain, hail, or dust. In addition, the vortex generating members positioned along at least a part of the first longitudinally extending edge generates vortices and mixing of the airstream upstream of the first longitudinally extending edge on the suction side of the wind turbine blade. Hereby, the boundary layer is stabilized across the transition from the protection cover to the wind turbine blade surface over the first edge. The positioning of vortex generating members has in this way been seen to effectively eliminate the lift reducing and/or drag increasing effects of any step from the protection cover to the wind turbine blade surface.

Hereby is obtained a protection cover which need not be fitted to the wind turbine blade with filler material for smoothing out or filling out the transition or step between the cover and the blade surface along its longitudinally extending surfaces. This greatly reduces the work and the time needed for attaching a leading edge protection cover to a wind turbine blade as well as making it possible to attach on-site without needing to lower the blade to the ground or establish a special working environment. Further, the weather range in which the system can be applied is widened. Furthermore, the life-time of the protection cover on the blade is increased as tapes and fillers are otherwise often seen to get damaged and/or peel off, and require repairing more regularly than the erosion protection system itself. Rather, the protection cover according to the invention is advantageous in that it can be mounted and attached to a wind turbine blade by few and simple operations and requiring only basic tools. This enables the protection cover to be attached on an existing wind turbine blade optionally while mounted, for example from a platform or using rope-access. Additionally, the method can be performed in the open with for example no need for special vacuum generating equipment, positioning jigs, heating systems, or the like. Further, the leading edge protection of the wind turbine can be established relatively fast by the simple attachment of the protection cover which is especially advantageous when to be applied as repair or maintenance operation on site and especially for blades on offshore turbines where the working conditions may be acceptable for only short periods of time.

The leading edge protection cover is configured to be attached to the wind turbine blade such that it is statically fixed to the wind turbine blade. In other words, the leading edge protection cover is not a moveable cover which can dynamically change shape with respect to the wind turbine blade. The leading edge protection cover is configured so that its inner arcuate surface has a complementary shape to the outer surface portion of the wind turbine blade, that is the inner arcuate surface conforms to the outer surface portion of the wind turbine blade. The leading edge protection cover is statically fixed to the wind turbine blade; however, this may be a temporary attachment and the cover can be removed and replaced if necessary.

The vortex generating members are positioned on the outer arcuate surface of the protection cover such that they project away from the outer surface portion of the wind turbine blade when the protection cover is attached to the blade.

The vortex generating members are positioned on the outer arcuate surface of the protection cover along at least a part of the first longitudinally extending edge. The vortex generating members in this way are positioned on or close to the first longitudinally extending edge, adjacent to or with a distance to the first longitudinally extending edge. The vortex generating members may be positioned with the same or one or more different distances to the first longitudinally extending edge such as in one or two rows along the first longitudinally extending edge.

The vortex generating members may be positioned with the same or different distances between neighbouring members. In this way the members may for example be placed closer to each other towards the root end of the wind turbine blade.

The vortex generating members are positioned along at least a part of the first longitudinally extending edge such as preferably along the entire length of the first longitudinally extending edge. Alternatively, the vortex generating members may be positioned at least along a central part of the first longitudinally extending edge such as along 50-90% of the entire length of the first longitudinally extending edge.

The first and second longitudinally extending edges of the protection cover are preferably substantially straight edges but may optionally be curved or piece-wise straight or combinations hereof or in any shape considered best for forming the transition from the protection cover to the wind turbine blade surface. The outer and inner surfaces are arcuate or generally U-shaped. The inner and outer arcuate surfaces may be shaped to yield a decreasing thickness of the protection cover towards the longitudinally extending edges. Hereby the height of the edge or step from the protection cover to the wind turbine blade surface is reduced. Further, the protection cover hereby has an increased thickness near the leading edge where the wear and damage of the wind turbine blade is the highest.

The outer surface portion typically extends across the leading edge such that the protection cover acts to cover a part of both the suction side surface and the pressure side surface of the wind turbine blade. The protection cover may extend a similar distance to both sides of the leading edge, or extend a larger distance onto the pressure side than onto suction side, or vice versa. The protection cover may be of equal or similar cross sectional width along the length of the cover or may have a varying width for example such as to cover a larger part of the wind turbine blade profile closer to the tip end of the blade. Hereby, the leading edge protection covers a larger part of the blade profile towards the tip end where the velocities of the impacting particles and projectiles are larger.

Because the blade tip and the outermost part of a wind turbine blade are exposed to particles of higher velocities and thereby have a higher risk of erosion damage, the leading edge protection is preferably shaped to protect the outermost part of the blade leading edge next to or including the blade tip, such as for example to the outermost 5-40% of the length of the leading edge such as the outermost 10-20%.

The vortex generating members are formed integrally with the protection cover. Hereby is obtained a more robust and wear-resistant protection cover with reduced risk of the vortex generating members tearing loose during operation of the wind turbine. Additionally, the vortex generating members can hereby be formed with the same flexibility as the protection cover which needs to be moulded with some flexibility to be able to follow the continuously changing and complex deformation patterns of the wind turbine blade. This aspect is increasingly important the longer the protection cover. Further, the protection cover can be manufactured and prepared in advance and ready to be attached to a wind turbine blade in a few and relatively simple operations.

According to an embodiment the protective cover comprising the number of vortex generating members is moulded of a flexible plastic material such as a polyurethane or epoxy. Hereby the protective cover including the vortex generating members can be made sufficiently flexible to be able to deform and flex together with the wind turbine blade. The bonding or attachment between the protection cover and the wind turbine blade surface is thereby subjected to lower loads and the risk of the protection cover loosening or partially tearing off is considerably reduced.

In a further embodiment, the vortex generating members comprise a body of a tetrahedron-like shape protruding from the outer arcuate surface of the protection cover. By tetrahedron-like shape is meant that the body comprises three surfaces protruding from the outer surface of the protection cover and that the surfaces of the body may be flat and/or curved. Hereby the vortex generating members attain a shape which both provides for the same or similar vortex generating properties of traditional fin-like vortex generators and at the same time enables the members to be cast or moulded integrally with the other parts of the protection cover and preferably of the same material. By the body of a tetrahedron-like shape the vortex generating member attains a volume to realize the desired stiffness of the member.

In an embodiment the tetrahedron-like shaped body according to the above further comprises a pressure surface, a suction surface and a back surface, wherein the back surface faces towards the first longitudinally extending edge and the pressure surface faces towards the tip end or the root end of the blade when the protection cover is attached on the blade. Hereby the vortex generating member is shaped such as to effectively introduce the desired mixing downstream of the edge of the protection cover which stabilizes the boundary layer and increases the lift of the wind turbine blade. In an embodiment the vortex generating members are arranged in pairs with the pressure surface facing alternatingly towards the tip end or the root end of the blade. Hereby each pair of vortex generating members act to generate counter-rotating vortices.

The pressure surface is in an embodiment curved inwardly (that is, a concave shape) thereby being shaped to effectively obtain favourable flow properties.

In embodiments, the back surface and/or the pressure surface extends substantially perpendicularly from the outer arcuate surface. Hereby the pressure surface can be shaped much like a traditional fin-like vortex generator with the view to alter the flow over the blade surface as desired to encourage boundary layer mixing, making the boundary layer more stable and delaying separation. Further, the back surface hereby aids in providing the needed stiffness of the body of the vortex generating member and without affecting the flow properties.

According to a further embodiment, the vortex generating members comprise a body of increasing height from the outer arcuate surface in a direction away from the leading edge towards the first longitudinally extending edge. The vortex generating members may protrude a maximum height from the outer arcuate surface in the range of 0.2-0.7% of a chord length of the wind turbine blade and/or in the range of 2-10 mm. Hereby is obtained an effective mixing of the airflow for stabilizing the boundary layer without negatively affecting the flow around the wind turbine blade.

In an embodiment, the vortex generating members are positioned with a distance between the vortex generating member and the first longitudinally extending edge, the distance being in the range of 2-30 mm such as in the range of 7-15 mm. It has been found that the vortex generating members hereby act to affect the boundary layer such as to in effect hide the geometric discontinuity or stepped surface between the protection cover and the wind turbine blade surface, thereby generating an improved lift characteristic.

According to a further aspect, the invention relates to a wind turbine blade extending a length between a root end and a tip end of the blade, and extending a width between a trailing edge and a leading edge, the wind turbine blade comprising an outer surface portion comprising at least a part of the leading edge, and further comprises a leading edge protection cover according to any of the previous attached to the outer surface portion of the wind turbine blade and with the first longitudinally extending edge being attached to a suction side of the wind turbine blade. The advantages hereof are as described in relation to the leading edge protection cover in the previous.

In embodiments, the protection cover is attached to the outer surface portion of the blade by an adhesive and/or by attachment means such as screws, bolts and/or rivets placed between the vortex generating members and the first longitudinally extending edge. Hereby is obtained an effective attachment of the protection cover which can optionally be performed on blades in the open, on site, or even on blades mounted on the wind turbine as the type of attachment may be performed by simple hand operations and simple tools without any requirements such as for example to a special atmosphere (apart from weather conditions matching the operating window for the adhesive used) or special manufacturing equipment or machinery. Further, the use of attachment means placed between the vortex generating means and the first longitudinally extending edge is advantageous in that the vortex generating members additionally act to hide the surface discontinuities or unevenness created by the attachment means. In this way the vortex generating members function to stabilize the boundary layer not only despite the edge between the protection cover and the blade surface but also despite the surface irregularities caused by the attachment means.

In one embodiment, the leading edge protection cover is relatively stiff to further facilitate for fastening by attachment means such as screws, bolts and/or rivets. In this embodiment, the stiffness of the leading edge protection cover is at least 500 MPa×mm, where stiffness is calculated as the e-modulus of the leading edge protection cover multiplied by the thickness of the leading edge protection cover. If the leading edge protective cover has a variation in thickness then it is preferred that at least the parts of the leading edge protection cover with the highest thickness have a stiffness of at least 500 MPa×mm, and more preferably all parts of the leading edge protection cover have a stiffness of at least 500 MPa×mm. The stiffness of the leading edge protection cover is at most 250 GPa×mm. More preferred, the stiffness of the leading edge protection cover is in the range of 1 GPa×mm to 100 GPa×mm.

The thickness of the leading edge protection cover is typically about 400 μm to about 5 mm. For stiffer leading edge protection covers, it is preferred that the thickness is about 1 to 5 mm and more preferably between 1.5 to 4 mm. In one embodiment, the minimum thickness is about 1 to 2 mm and the maximum thickness is about 3 to 5 mm.

According to a further aspect, the invention relates to a method of preparing a wind turbine blade with a leading edge protection cover, the wind turbine blade extending a length between a root end and a tip end of the blade, and extending a width between a trailing edge and a leading edge and where the wind turbine blade comprises an outer surface portion comprising at least a part of the leading edge, the method comprising:

moulding a leading edge protection cover comprising a number of vortex generating members and according to any of the above mentioned embodiments,

attaching the leading edge protection cover to the outer surface portion of the wind turbine blade such as to cover the part of the leading edge and such that the vortex generating members are positioned on a suction side of the wind turbine blade. The advantages hereof are as described in relation to the leading edge protection cover in the previous.

In an embodiment, the leading edge protection cover is moulded in a mould comprising a number of recesses for the moulding of the vortex generating members. Hereby the protection cover including the vortex generating members can be moulded in one part and optionally of the same material and in one operation. The vortex generating members are hereby formed integrally with the other parts of the protection cover with minimal risk of any of the vortex generating members being torn off or in detaching from the surface of the cover.

The method steps as described in the preceding may form part of a manufacture of the wind turbine blade or may alternatively or additionally be performed as post processing during repair or maintenance of the wind turbine blade. In other words the leading edge protection cover can be attached to a wind turbine blade when first manufactured and is also very well suited to be applied at a later time to existing wind turbine blades. A special advantage is, that the preparation method can be performed on blades in the open, on site, or even on blades mounted on the wind turbine as the method may be performed by simple hand operations and simple tools without any requirements such as for example to a special atmosphere (apart from weather conditions matching the operating window for the paint used) or special manufacturing equipment or machinery.

### BRIEF DESCRIPTION OF THE DRAWINGS

In the following different embodiments of the invention will be described with reference to the drawings, wherein:

FIG. 1 shows a wind turbine blade comprising a leading edge protection cover,

FIGS. 2A and B show a wind turbine blade comprising a leading edge protection cover in a partially perspective view and the leading edge area comprising a leading edge protection cover according to an embodiment of the invention in an enlargement,

FIGS. 3A-C illustrate the wind flow around a wind turbine blade profile without and with a protection cover, and with a protection cover according to an embodiment of the invention, respectively,

FIGS. 4A-E illustrate different shapes of vortex generation members to be positioned on a protection cover according to different embodiments of the invention,

FIG. 5 illustrates the positioning of a vortex generating member on a protection cover as seen in a perspective and cross-sectional view, and FIGS. 6A-D illustrate different shapes of a part of a vortex generation member as seen in a top view.

### DETAILED DESCRIPTION OF THE DRAWINGS

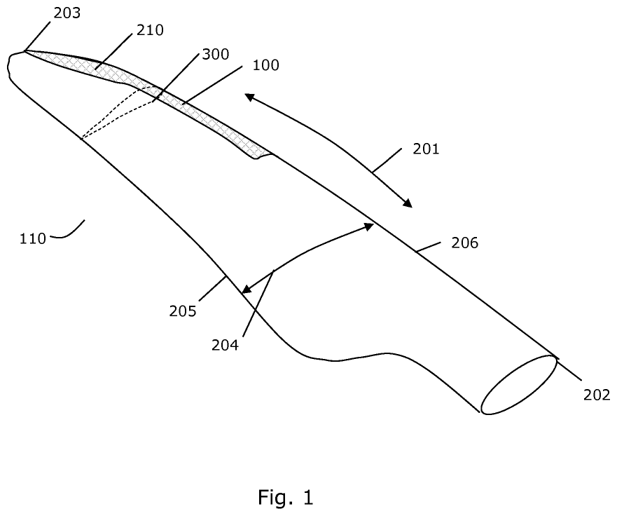

FIG. 1 shows a wind turbine blade 110 extending a length 201 between a root end 202 and a tip end 203 of the blade, and extending a width between a trailing edge 205 and a leading edge 206 as indicated by the arrow 204. An outer surface portion 210 of the wind turbine blade covers a part of the leading edge 206 and is provided with a leading edge protection cover 100 according to the invention.

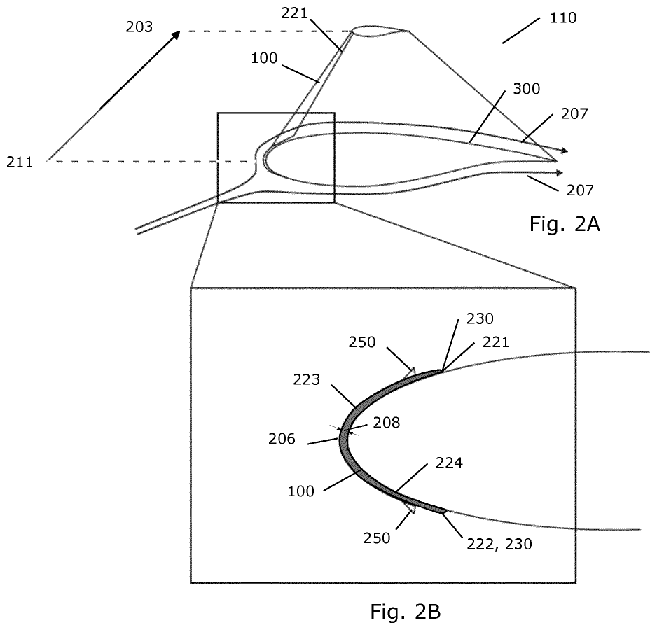

FIG. 2A illustrates a part of the wind turbine blade 101 as seen in a cross-sectional view corresponding to the indicated profile 300 in FIG. 1 in a mid-blade position 211 and the outer part of the blade towards the tip 203 in a perspective view. The foremost area around the leading edge 206 is seen in an enlargement in FIG. 2B. An outer or exterior surface portion 210 of the blade covers and extends across the leading edge 206 of the blade. In FIG. 2A the arrows 207 indicate the flow paths around the wind turbine blade under normal wind turbine operation below rated power. The wind turbine blade 110 comprises a leading edge protection cover 100 attached to the surface portion 210 thereby covering at least a part of the leading edge of the blade.

The leading edge protection cover 100 comprises a first 221 and a second 222 longitudinally extending edge, and an outer 223 and an inner 224 arcuate surface extending there between. The thickness 208 of the cover is the distance between the outer 223 and inner 224 arcuate surfaces orthogonal to the inner 224 arcuate surface. The thickness 208 is typically substantially constant (i.e. having a thickness variation of less than 20%) for the whole protection cover. In some embodiments the protection cover has a maximum thickness in a part of the cover between 221 and 222 that is more than 20% higher than a minimum thickness of the protection cover as described elsewhere. The first longitudinally extending edge 221 is attached to a suction side of the wind turbine blade. The protection cover 100 further comprises a number of vortex generating members 250 positioned on the outer arcuate surface 223 of the protection cover and along at least a part of the first longitudinally extending edge 221 and thereby on the suction side of the wind turbine blade. The vortex generating members 250 are positioned upstream from the first longitudinally extending edge 221 of the protection cover and thereby upstream of the step or discontinuity, 230 between the protection cover and the blade surface. The vortex generating members 250 may additionally be positioned along at least a part of the second longitudinally extending edge 222 on the pressure side of the wind turbine blade as indicated in FIG. 2B.

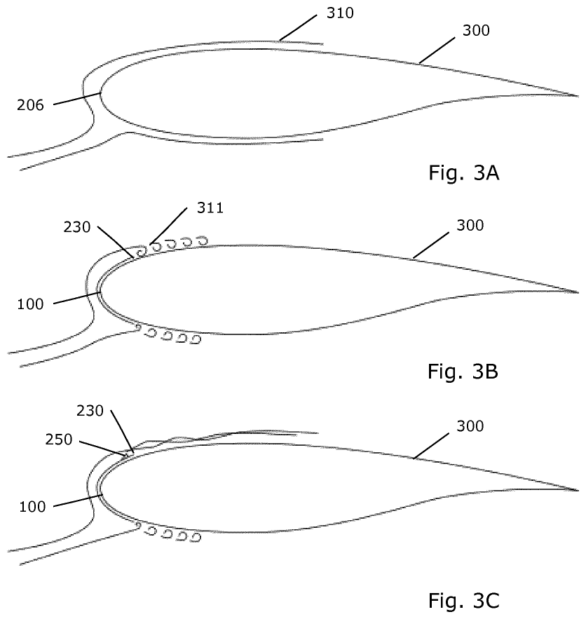

FIGS. 3A-C illustrate how a leading edge protection cover 100 affects the flow around a wind turbine blade profile 300, and the advantageous functioning of the vortex generating members on the protection cover. In FIG. 3A is shown the typical laminar flow 310 around a wind turbine blade profile 300. In FIG. 3B is illustrated how the attachment of a traditional protection cover 100 creates stepped surfaces or a discontinuity 230 on both the suction side and the pressure side causing the boundary layer to separate 311 and a loss of lift. In FIG. 3C is illustrated the effect of a protection cover 100 according to the invention and comprising a vortex generating member 250 positioned upstream from the edge of the cover. The vortex generator 250 on the protection cover creates turbulence in the flow causing mixing in the air flow thereby stabilizing the boundary layer along the suction surface. In this way the vortex generating member 250 effectively hides the geometric discontinuity between the protection cover 100 and the blade surface increasing the lift.

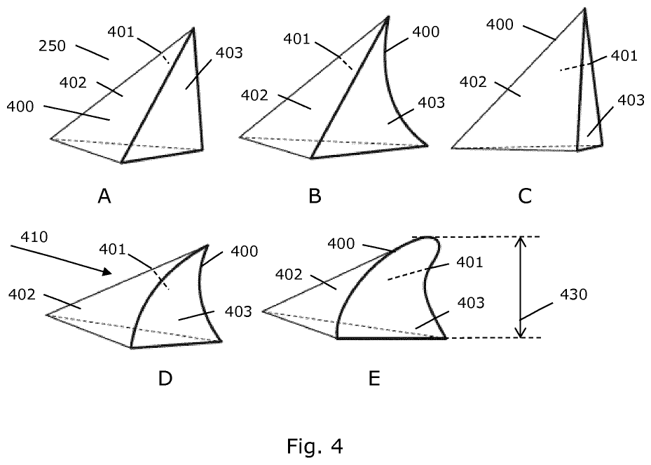

FIGS. 4A-E illustrate different preferred shapes of vortex generation members 250 to be positioned on the protection cover 100. Here, the vortex generating members 250 comprise a body 400 of a tetrahedron-like shape protruding from the outer arcuate surface 223 of the protection cover 100. The tetrahedron-like shaped bodies 400 here all comprise a pressure surface 401, a suction surface 402 and a back surface 403. The surfaces are oriented such that the back surface 403 faces towards the first longitudinally extending edge 221. The vortex generating members 250 in FIG. 4 are thus seen in a perspective view from the back toward the leading edge and against the general direction of the wind inflow as indicated by the arrow 410 for the member in FIG. 4D. The pressure surface 401 faces towards the tip end 203 of the blade. The body 400 of the vortex generating members 250 has a height as measured from the outer arcuate surface which increases in the direction from the leading edge 206 towards the first longitudinally extending edge 221, i.e. in the general direction of the wind flow, 410. The maximum height 430 of one of the vortex generating members 250 is indicated in FIG. 4E. The maximum height 430 is preferably in the range of 0.2-0.7% of a chord length of the wind turbine blade and/or in the range of 2-10 mm.

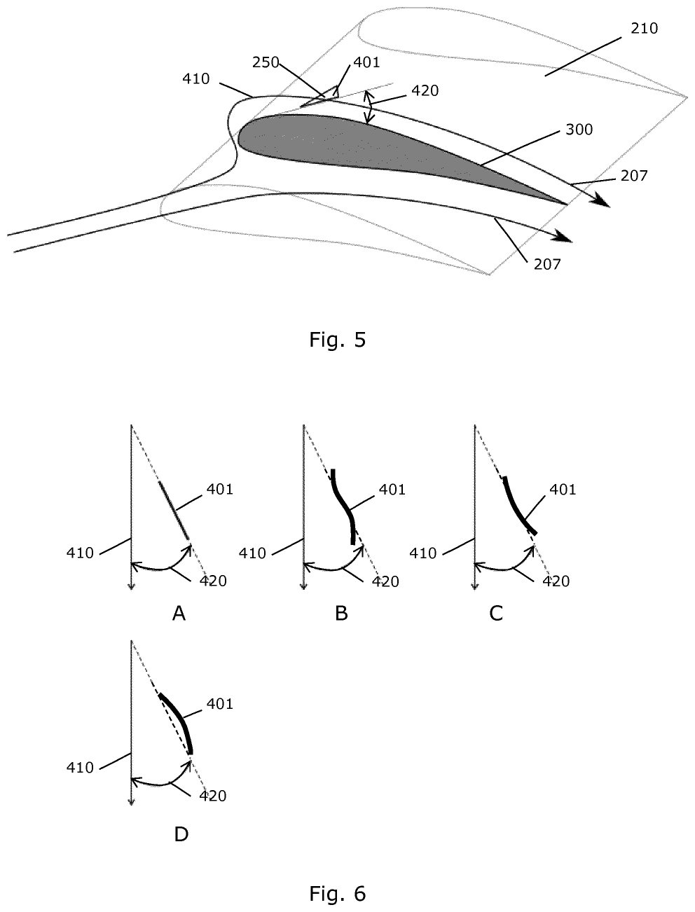

The angling 420 of the pressure surface 401 relative to the general direction of the wind inflow 410 is illustrated in FIG. 5 and for some different pressure surface shapes in FIGS. 6A-D as seen in a top view.

The criteria for angling and for the shape of the pressure surface 401 and/or suction surface 402 of the body of the vortex generating member 250 are generally that the pressure surface 401 is angled and shaped to obtain favourable flow properties. The shape and angling of this surface therefore in general follow the same design rules as for traditional fin-like type vortex generators. Furthermore, the suction side 402 is shaped and angled to obtain a body volume and enough material volume to achieve the desired stiffness of the vortex generating member.

The angle 420 between the pressure surface 401 and the general direction of the wind flow 410 is typically around 5-20 degrees. In its simplest form, the pressure surface may be a flat surface as illustrated in FIG. 6A. In the embodiments shown in FIG. 6B and C, the pressure surfaces 401 curve at least partly inward guiding the airflow accordingly. Alternatively, as shown in FIG. 6D, the pressure surface 401 may curve or bulge outwardly towards the incoming air, i.e. form a convex shape. In this way the shape of the vortex generating members can be tuned to obtain the desired altering of the flow along the surface of the blade which enables the ‘hiding’ of the geometric discontinuity between the protection cover 100 and the blade surface. The protection cover is preferably moulded in a relatively soft and flexible material such as a soft polyurethane to withstand and follow the deformations of the wind turbine blade. By the proposed tetrahedron-like shapes of the vortex generating members, these can be formed integrally with the protection cover and preferably of the same material and still have the necessary stiffness to cause the vortex generation and mixing of the airflow.

While preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

1. A leading edge protection cover for attachment to a wind turbine blade, the wind turbine blade extending longitudinally between a root end and a tip end of the blade, and extending transversely between a trailing edge and a leading edge,
wherein the protection cover comprises first and second longitudinally extending edges, and outer and inner arcuate surfaces extending there between, and the inner arcuate surface is shaped to be attached, in use, to an outer surface portion of the wind turbine blade comprising at least a part of the leading edge with the first longitudinally extending edge being attachable to a suction side of the wind turbine blade, and the protection cover is configured to be statically fixed to the wind turbine blade,
wherein the protection cover further comprises a number of vortex generating members positioned on the outer arcuate surface of the protection cover along at least a part of the first longitudinally extending edge and the vortex generating members are formed integrally with the protection cover; and
the vortex generating members are positioned on the outer arcuate surface of the protection cover such that they project away from the outer surface portion of the wind turbine blade when the protection cover is attached to the blade.

2. The leading edge protection cover according to claim 1, wherein the vortex generating members comprise a body of a tetrahedron-like shape protruding from the outer arcuate surface of the protection cover.

3. The leading edge protection cover according to claim 2, wherein the tetrahedron-like shaped body comprises a pressure surface, a suction surface and a back surface, wherein the back surface faces towards the first longitudinally extending edge and the pressure surface faces towards the tip end or the root end of the blade when the protection cover is attached on the blade.

4. The leading edge protection cover according to claim 3, wherein the pressure surface is curved inwardly.

5. The leading edge protection cover according to claim 3, wherein the back surface extends substantially perpendicularly from the outer arcuate surface.

6. The leading edge protection cover according to claim 3, wherein the pressure surface extends substantially perpendicularly from the outer arcuate surface.

7. The leading edge protection cover according to claim 1, wherein the vortex generating members comprise a body of increasing height from the outer arcuate surface in a direction from the leading edge towards the first longitudinally extending edge.

8. The leading edge protection cover according to claim 1, wherein the vortex generating members protrude a maximum height from the outer arcuate surface in the range of 0.2-0.7% of a chord length of the wind turbine blade and/or in the range of 2-10 mm.

9. The leading edge protection cover according to claim 1, wherein the protective cover comprising the number of vortex generating members is moulded of a flexible plastic material such as a polyurethane or epoxy.

10. The leading edge protection cover according to claim 1, wherein the vortex generating members are positioned with a distance between the vortex generating member and the first longitudinally extending edge, the distance being in the range of 2-30 mm such as in the range of 7-15 mm.

11. A wind turbine blade extending a length between a root end and a tip end of the blade, and extending a width between a trailing edge and a leading edge, the wind turbine blade comprising an outer surface portion comprising at least a part of the leading edge,
wherein the wind turbine further comprises a leading edge protection cover according to claim 1 attached to the outer surface portion of the wind turbine blade and with the first longitudinally extending edge being attached to a suction side of the wind turbine blade.

12. The wind turbine blade according to claim 11, wherein the protection cover is attached to the outer surface portion of the blade by an adhesive.

13. The wind turbine blade according to claim 11, wherein the protection cover is attached to the outer surface portion of the blade by attachment means such as screws, bolts and/or rivets placed between the vortex generating means and the first longitudinally extending edge.

14. The wind turbine blade according to claim 13, wherein the leading edge protection cover has a stiffness in the range of 500 MPa×mm to 250 GPa×mm, preferably the leading edge protection cover has a stiffness in the range of 1 GPa×mm to 100 GPa×mm.

15. A method of preparing a wind turbine blade with a leading edge protection cover, the wind turbine blade extending a length between a root end and a tip end of the blade, and extending a width between a trailing edge and a leading edge, the wind turbine blade comprising an outer surface portion comprising at least a part of the leading edge, the method comprising:
moulding a leading edge protection cover comprising a number of vortex generating members and according to claim 1,
attaching the leading edge protection cover to the outer surface portion of the wind turbine blade such as to cover the part of the leading edge and such that the vortex generating members are positioned on a suction side of the wind turbine blade.

16. The method of preparing a wind turbine blade according to claim 15, wherein the leading edge protection cover is moulded in a mould comprising a number of recesses for the moulding of the vortex generating members.

17. The method of preparing a wind turbine blade according to claim 15, wherein the method steps form part of a manufacture of the wind turbine blade.

18. The method of preparing a wind turbine blade according to claim 15, wherein the method step of attaching the leading edge protection cover is performed as post processing during repair or maintenance of the wind turbine blade.
